(19) United States
(12) Patent Application Publication
(10) Pub. No.: US 2012/0003510 A1
(43) Pub. Date: Jan. 5, 2012

(54) VEHICLE BATTERY TEMPERATURE CONTROL SYSTEM AND METHOD

(75) Inventor: Ronald S. EISENHOUR, West Bloomfield, MI (US)

(73) Assignee: NISSAN TECHNICAL CENTER NORTH AMERICA, INC., Farmington Hills, MI (US)

(21) Appl. No.: 12/828,149

(22) Filed: Jun. 30, 2010

(51) Int. Cl. H01M 10/50

(52) U.S. Cl. 429/50; 429/62

(57) ABSTRACT

A vehicle battery temperature control system includes a battery, a housing and a heat exchanger. The battery is operable to discharge thermal energy, and has a heat sink configured to transfer the thermal energy from the battery. The housing has a chamber that is configured to receive the battery and contain a saturated liquid coolant that substantially immerses the heat sink so that the coolant receives the thermal energy from operation of the battery to cause a phase change of the coolant from a liquid phase to a vapor phase. The heat exchanger is configured to receive vapor phase coolant from the chamber and remove thermal energy from the vapor phase coolant to change the coolant from the vapor phase to the liquid phase, and is further configured to return the liquid phase coolant to the chamber.

### BACKGROUND

1. Field of the Invention

The present invention generally relates to vehicle battery temperature control. More specifically, the present invention relates to a vehicle battery temperature control system and method that use liquid phase and vapor phase coolant to maintain desired battery temperature.

2. Background Information

A hybrid electric vehicle (HEV) or full electric vehicle relies substantially or completely on battery power for operation. Therefore, it is desirable to maintain the battery cells at an optimal operating temperature. As understood in the art, battery cells are often best suited to operate in a somewhat small optimum temperature range. Consequently, the life or durability of the battery, as well as the performance of the battery, such as the available power provided by the battery, can be adversely affected by temperatures above and below that optimum temperature range. Furthermore, to optimize battery performance, it is essential to maintain temperature uniformity among the cells of a battery, for example, multiple battery cells assembled in a battery module.

Typically, batteries of HEVs or full electric vehicles can be cooled by air, or by a liquid coolant that, for example, has a high water content. However, when cooling fluid is provided by a pumping mechanism, such as a fan or liquid pump, in a single phase (e.g., a liquid phase), temperature gradients will exist along the flow path. That is, because heat is transferred at all points along the flow path, the temperature of the liquid coolant increases from the entrance to the exit of the battery assembly. These gradients can be somewhat reduced by increasing fluid flow rate, which consumes greater energy. Also, shortened parallel flow paths along the cells can be used instead of a serial flow path.

One example of a cooling system uses the vehicle's air-conditioning (A/C) system to cool the battery structure. However, this type of arrangement requires that considerable energy be expended to pump the refrigerant and achieve the desired cooling effects. Moreover, if the A/C system does not operate, the refrigerant will eventually all vaporize within the battery assembly, and as a consequence, the pressure and temperature inside the battery assembly will elevate. This elevation in pressure and/or temperature could result in lost battery performance due to temperature gradients that compromise the optimum operating temperature. Furthermore, the A/C system of a vehicle generally operates at temperatures around 5 degrees Celsius, which is colder than the optimum operating battery temperature range. Accordingly, a control system is required that, for example, pulses cold refrigerant into the battery assembly so as not to overcool the battery. However, this pulsing can create large and detrimental temperature gradients within the battery assembly, thus degrading the battery's life and performance.

### SUMMARY

It has been discovered that to improve temperature control for a vehicle battery, coolant in liquid and vapor phase can be used.

In view of the state of the known technology, one aspect of the present invention is to provide a vehicle battery temperature control system including a battery, a housing and a heat exchanger. The battery is operable to discharge thermal energy, and has a heat sink configured to transfer the thermal energy from the battery. The housing has a chamber that is configured to receive the battery and contain a saturated liquid coolant that substantially immerses the heat sink so that the coolant receives the thermal energy from operation of the battery to cause a phase change of the coolant from a liquid phase to a vapor phase. The heat exchanger is configured to receive vapor phase coolant from the chamber and remove thermal energy from the vapor phase coolant to change the coolant from the vapor phase to the liquid phase, and is further configured to return the liquid phase coolant to the chamber.

### BRIEF DESCRIPTION OF THE DRAWINGS

Referring now to the attached drawings which form a part of this original disclosure:

FIG. 1 is an exemplary diagram of an electric vehicle employing a vehicle battery temperature control system in accordance with an illustrated embodiment;

FIG. 2 is a detailed exemplary diagram of the vehicle battery temperature control system employed in the vehicle shown in FIG. 1;

FIG. 3 is a graph illustrating an exemplary relationship between the percentage of coolant liquid by volume versus the coolant liquid temperature in the system of FIG. 2;

FIG. 4 is a graph illustrating an exemplary relationship between the heat of vaporization and the coolant liquid temperature in the system of FIG. 2;

FIG. 5 is a graph illustrating an exemplary relationship between the saturated coolant pressure and the coolant liquid and vapor temperature in the system of FIG. 2;

FIG. 6 is an exemplary diagram of a vehicle battery temperature control system in accordance with another illustrated embodiment;

FIG. 7 is an exemplary diagram of a vehicle battery temperature control system in accordance with a further illustrated embodiment; and

FIG. 8 is an exemplary diagram of a vehicle battery temperature control system in accordance with another illustrated embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

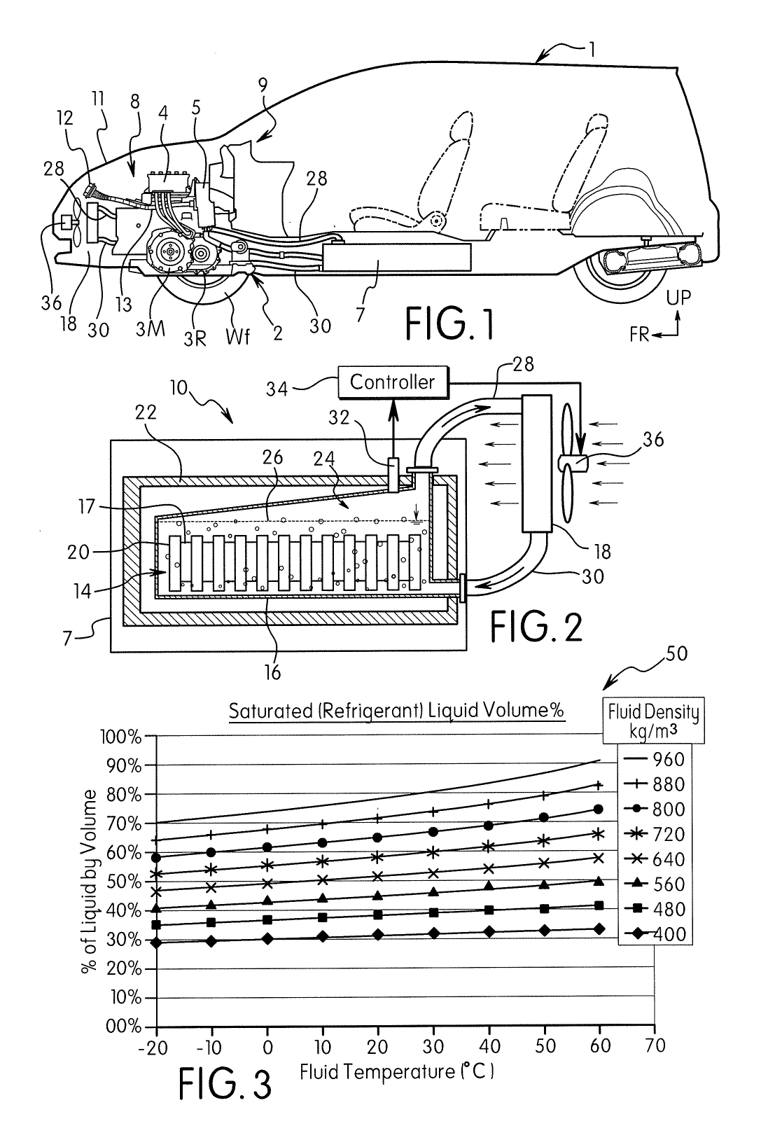

Referring initially to FIGS. 1 and 2, a portion of an electric vehicle 1 is partially illustrated with a vehicle battery temperature control system 10 in accordance with a first embodiment. In the figures, an arrow FR indicates a frontward direction of the vehicle, and an arrow UP indicates an upward direction of the vehicle.

In this embodiment, the vehicle 1 includes a vehicle body 2 that supports a power unit 3 that includes an electric motor 3M and a reduction gear 3R. The electric motor 3M and the reduction gear 3R are configured as a single integrated unit. The electric motor 3M is installed in a front section of the vehicle body 2. The electric motor 3M is operatively coupled to a pair of front wheels Wf in a conventional manner to rotate the front wheels Wf. Thus, the electric motor 3M propels the vehicle 1. In addition to the electric motor 3M, various comparatively heavy electrical components are mounted on the vehicle body 2 In particular; as shown in FIGS. 1 and 2, the vehicle body 2 also supports various comparatively heavy electrical components including, but not limited to, an inverter 4, a circuit box 5, a charger (not shown) and a battery unit 7.

In this embodiment, the electric motor 3M, the inverter 4 and the circuit box 5 are arranged in a frontward portion of the vehicle 1. Meanwhile, the battery unit 7 is arranged in a longitudinally middle portion of the vehicle 1 and the charger (not shown) is arranged in a rearward portion of the vehicle 1. In this way, a plurality of electrical components are arranged to be distributed appropriately in the longitudinal direction of the vehicle 1 such that the weight of the vehicle 1 can be more easily balanced with respect to the longitudinal direction.

As shown in FIG. 1, a front compartment 8 is formed in a frontward portion of the vehicle 1. The front compartment 8 is a space surrounded by a dash panel 9 on a rearward side, a fender panel (not shown) on each of both widthwise sides, and a bumper (not shown) and grill (not shown) on a frontward side. A hood 11 is arranged and configured such that the hood 11 can open and close an upper opening of the front compartment 8. The power unit 3 (the electric motor 3M and the reduction gear 3R), the inverter 4, the circuit box 5, and other components are housed inside the front compartment 8.

While only one charging port 12 is illustrated, typically, two or more charging ports could be provided. A low-voltage charging port would be provided to conduct charging at a comparatively low (household) voltage (e.g., 100V or 200V). A high-voltage charging port would be provided to conduct charging at a comparatively high voltage (e.g., 500 V). The charging harnesses 13 are connected to the charging ports. Low-voltage electric power supplied to the low-voltage charging port from a low-voltage power supply cord is converted to a higher voltage by the charger (which includes a transformer (not shown) for converting a low voltage to a higher voltage) and the higher voltage power is supplied to the battery cells of a battery 14 (FIG. 2) inside the battery unit 7 through the circuit box 5 (conductor portions inside the circuit box 5). High-voltage electric power supplied to the high-voltage charging port from a high-voltage power supply cord is supplied to the battery 14 inside the battery unit 7 through the circuit box 5 (conductor portions inside the circuit box 5). The high-voltage charging port enables charging to be completed at a faster rate. In addition to the transformer, the charger is also provided with additional electrical components such components as a rectifier circuit for converting alternating current to direct current and a filter.

As shown in more detail in FIG. 2, in addition to the battery 14, the vehicle battery temperature control system 10 also includes a housing 16 and a heat exchanger 18. The battery 14 includes a plurality of stacked battery cells 17 and a heat sink 20 that can be configured as a single heat sink or a plurality of heat sinks, and can have any suitable heat exchange features as understood in the art. During operation, the battery 14 becomes heated and thus discharges thermal energy. The heat sink 20 can transfer the thermal energy generated by the battery 14 away from the battery 14, or can transfer thermal energy to the battery 14.

The housing 16 includes an insulation member 22 configured to substantially enclose the housing 16. As illustrated, the battery 14 and heat sink 20, housing 16, insulation member 22 and associated components described herein are included in the battery unit 7 shown in FIG. 1. The housing 16 defines a chamber 24 that is configured to receive the battery 14 and contain a saturated liquid coolant 26 that substantially immerses the heat sink 20 so that the coolant receives the thermal energy from operation of the battery 14 to cause a phase change of the coolant from a liquid phase to a vapor phase. In this example, the coolant 26 includes 1,1,1,2-Tetrafluoroethane (known as R-134a) or 2,3,3,3-Tetrafluoroprop-1-ene (known as HFO-1234yf). However, the coolant 26 can include any suitable type of liquid or refrigerant. Furthermore, the chamber 24 can be configured such that the saturated liquid coolant 26 in the chamber 24 completely immerses the heat sink 20. As shown in graph 50 of FIG. 3, the liquid volume of common types of refrigerants are reasonably stable across the expected ambient temperature range.

The heat exchanger 18 is configured in an elevated position with respect to the chamber 24 to receive vapor phase coolant from the chamber 24, and remove thermal energy from the vapor phase coolant to change the coolant from the vapor phase to the liquid phase. In this example, the heat exchanger 18 receives the vapor phase coolant from the chamber 24 via a conduit 28 that can be a tube made of rubber, metal or any other suitable material. The heat exchanger 18 is further configured to return the liquid phase coolant to the chamber 24 via a conduit 30 that can be a tube made of rubber, metal or any other suitable material. In one configuration, the heat exchanger 18 includes a condenser that is fluidly coupled to receive the vapor phase coolant from the chamber 24 via conduit 28. The condenser is operable to remove heat from the vapor phase coolant to create the liquid phase coolant, and is fluidly coupled to return the liquid phase coolant to the chamber 24 via conduit 30.

It should be noted that the insulation member 22 ensures that the management of the temperature in the chamber 24 is principally controlled at the heat exchanger 18 (condenser). This is particularly beneficial when, for example, the battery 14 is a cold battery pack operating in a low ambient temperature condition. By limiting heat transfer or adding heat, for example, through warm airflow from the passenger cabin to the condenser, the self heating of the battery 14 can be used to reach the optimum operating temperature range.

As further shown in FIG. 2, the system 10 includes a sensor 32, a controller 34 and a fan 36. The sensor 32, controller 34, fan 36 are conventional components that are well known in the art. Since these components are well known in the art, these structures will not be discussed or illustrated in significant detail herein. Rather, it will be apparent to those skilled in the art from this disclosure that the components can be any type of structure and/or programming that can be used to carry out the present invention.

The sensor 32 is operable to detect when a characteristic of the vapor phase coolant is above a threshold, and to signal operation of the fan 36 that increases the removal of thermal energy by the heat exchanger 18 when the characteristic is above the threshold. In this example, the sensor 32 provides a signal to a controller 34 which determines whether the characteristic is above the threshold. If the characteristic is above the threshold, the controller 34 controls the fan 36 to operate. The fan 36 can be configured as a single fan or multiple fans.

The controller 34 can be any suitable type of computer, microprocessor or control device as known in the art. The controller 34 preferably includes a microcomputer with a control program that controls the operations as discussed below. The controller 34 can also include other conventional components such as an input interface circuit, an output interface circuit, and storage devices such as a ROM (Read Only Memory) device and a RAM (Random Access Memory) device. A memory circuit (not shown) stores processing results and control programs such as ones for the operations discussed herein. It will be apparent to those skilled in the art from this disclosure that the precise structure and algorithms for the controller 34 can be any combination of hardware and software that will carry out the functions of the present invention.

The sensor 32 includes a temperature sensor that is operable to sense a temperature of the vapor phase coolant in the chamber 24 as the characteristic. In this event, the threshold can be an upper temperature threshold, such as a temperature threshold at or about 45 degrees Celsius (see FIG. 5). Alternatively, or in addition, the sensor 32 includes a pressure sensor operable to sense a pressure in the chamber 24 as the characteristic. In this event, the threshold can be an upper pressure threshold, such as pressure at or about 1100 kPa (see FIG. 5). Naturally, any suitable temperature threshold or pressure threshold can be used.

Concerning the operation of the system 10, it is understood in the art that when a fluid, such as coolant 26, is contained in a saturated state, coolant in the liquid phase and in the vapor phase coexist at a specific temperature and pressure within the chamber 24. When heat (thermal energy) is added due to, for example, heating of the battery 14 during operation of the battery 14, temperature uniformity is maintained by the fluid vaporizing at the same or substantially the same pressure. This temperature stability and uniformity maintains the cells of the battery 14 at the same or substantially the same temperature within the battery 14. Moreover, since the phase change from a low energy content liquid phase to a high energy content vapor phase results in a density change, vapor bubbles are separated from the liquid by gravity. That is, vapor bubbles rise to the upper part of the chamber 24. Accordingly, the vapor phase coolant can flow via the conduit 28 into the heat exchanger 18, and is thus transported away from the heat source (i.e., the battery 14) without a pumping mechanism.

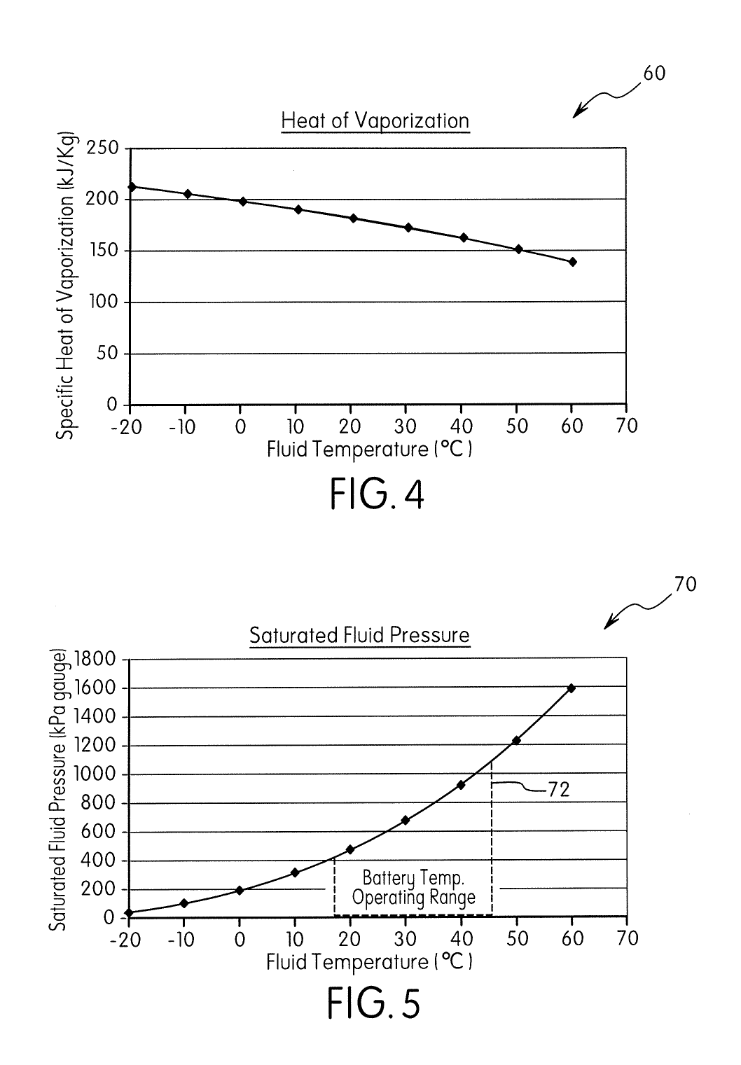

Moreover, the formation of bubbles absorbs considerable energy without causing a rise in temperature of the coolant 26, and the mixing action of the bubbles in moving toward the free surface of the coolant 26 toward the upper part of the chamber 24 further enhances the temperature uniformity in the battery 14. An example of a specific heat of vaporization for a common refrigerant that can be used as the coolant 26 is shown in graph 60 in FIG. 4.

Also, since the liquid phase coolant 26 is in a saturated state, temperature uniformity is maintained throughout the battery 14, and the change from the liquid phase to the vapor phase is used to quickly and naturally transport high energy content vapor phase coolant 26 to the heat exchanger 18, due to the vapor density of the vapor phase coolant 26 being much less than that of the surrounding liquid phase coolant 26. This action further enhances the convective heat transfer within the battery 14. The battery 14 can be permitted to heat up when the cooling fan 36 is not being operated, and can be maintained at slightly above the ambient air temperature of the heat exchanger 18 when the cooling fan 36 is operated.

In addition, varied airflow provided by fan 36 to the heat exchanger 18 assists in managing the pressure and corresponding operating temperature of the coolant 26 and battery 14. An example of the relationship of the pressure versus the liquid coolant temperature is shown in graph 70 of FIG. 5, with the optimum battery temperature range being identified by area 72. As discussed above, a temperature and/or pressure sensor 32 is used to signal the controller 34 to operate the cooling fan 36 in the appropriate manner to achieve the desired temperature of the coolant 26. The source of the airflow provided by the fan 36 can be air external to the vehicle 1 that is drawn in by the fan 36. Also, the source of the airflow can be pre-cooled or pre-heated air that is provided, for example, by the heating ventilating and air-conditioning (HVAC) system of the vehicle 1 or other means to assist the fan 36 and heat exchanger 18 in maintaining the coolant 26, and thus the battery 14, within the target temperature range.

Accordingly, the heat transfer from the vapor phase coolant to the environment external of the system 10 can be managed with the condensing heat exchanger (condenser) 18 and cooling fan 36. The reformation of liquid phase coolant from the vapor phase coolant by the heat exchanger 18 thus maintains the target pressure and corresponding target temperature of the coolant 26, which results in a stable temperature environment for the battery cell heat sink structure. The system 10 is inherently isothermal and does not require forced fluid flow within the battery 14 to perform the required heat exchange functions. Rather, the system 10 allows for the natural flow of high energy vapor phase coolant to the heat exchanger 18 as discussed above, instead of requiring, for example, a pump to force the flow of coolant to a heat exchanger.

That is, as understood in the art, the circulation (e.g., pumping) of saturated fluids, such as a liquid-vapor refrigerant, can be used to transport thermal energy from the battery 14 to the heat exchanger 18 and vice-versa. In such an arrangement, some liquid phase coolant can be exposed to the heat exchanger 18 along with the vapor phase coolant, so that thermal energy from that portion of the liquid and the vapor can be transferred by the heat exchanger 18 to an external environment, thereby cooling the vapor and that portion of the liquid. However, although the pumping action may facilitate improved heat transfer in the system 10, such pumping uses energy that can otherwise be used to power other components of the vehicle 1. Hence, the isothermal features of the system 10 are beneficial in that they can avoid the use of a pumping mechanism.

In addition, in the system 10 discussed above, and in the variations discussed below, a reservoir of the saturated coolant could also be maintained at, for example, a location away from the battery 24 and be pumped into the chamber 24 at a rate controlled by, for example, controller 34, to rapidly change the temperature of the liquid phase coolant.

### Second Embodiment

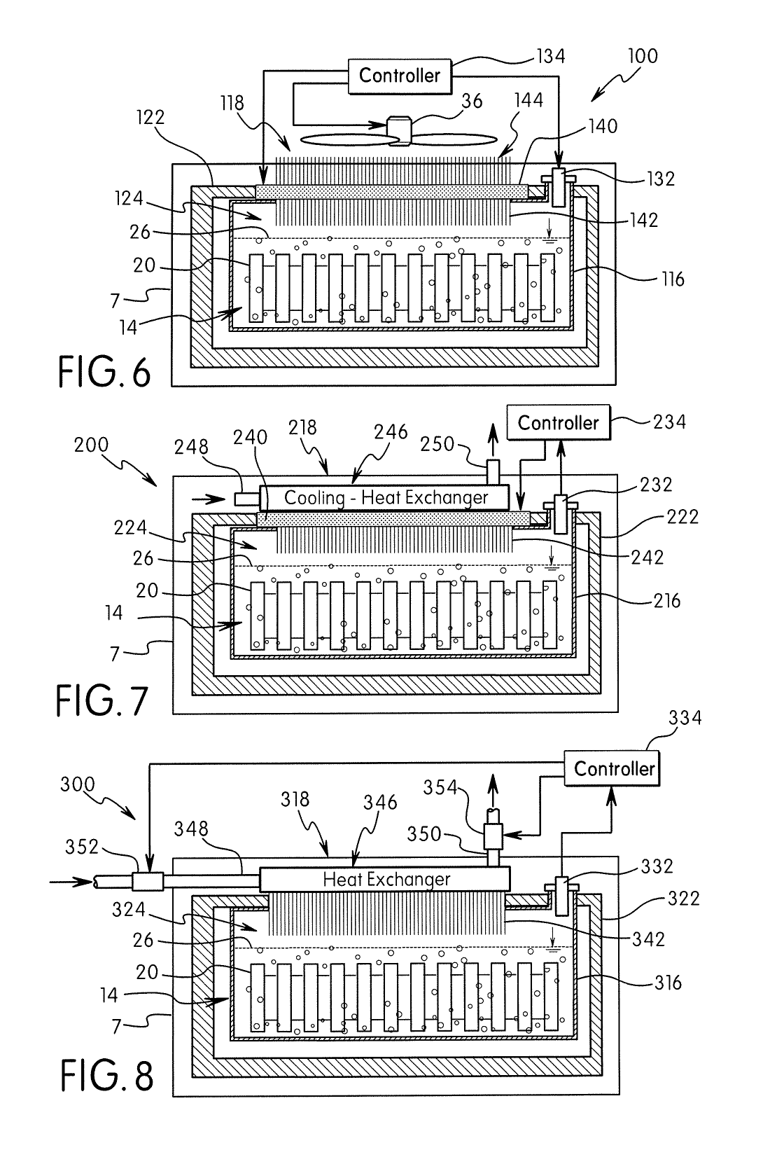

Referring now to FIG. 6, a vehicle battery temperature control system in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. The parts of the second embodiment that differ from the parts of the first embodiment will be indicated with different reference numerals.

The vehicle battery temperature control system 100 is illustrated in FIG. 6 in accordance with the second embodiment. The vehicle battery temperature control system 100 includes a battery 14 having a heat sink 20 similar to that described above with regard to vehicle battery temperature control system 10. The vehicle battery temperature control system 100 further includes a housing 116 and a heat exchanger 118. The housing 116 includes an insulation member 122 configured to substantially enclose the housing 116. As illustrated, the battery 14 and heat sink 20, housing 116, insulation member 122, heat exchanger 118 and associated components described herein are included in the battery unit 7 shown in FIG. 1.

The housing 116 defines a chamber 124 that is configured to receive the battery 14 and contain a saturated liquid coolant 26 that substantially immerses the heat sink 20 so that the coolant receives the thermal energy from operation of the battery 14 to cause a phase change of the coolant from a liquid phase to a vapor phase as in the vehicle battery temperature control system 10. In this example, the coolant 26 includes 1,1,1,2-Tetrafluoroethane (known as R-134a) or 2,3,3,3-Tetrafluoroprop-1-ene (known as HFO-1234yf). However, the coolant 26 can include any suitable type of refrigerant. Furthermore, the chamber 124 can be configured such that the saturated liquid coolant 26 in the chamber 124 completely immerses the heat sink 20 as discussed above with regard to vehicle battery temperature control system 10.

The heat exchanger 118 is configured in an elevated position with respect to the chamber 124 to receive vapor phase coolant from the chamber 124, and remove thermal energy from the vapor phase coolant to change the coolant from the vapor phase to the liquid phase. The heat exchanger 118 also can operate to add thermal energy to the vapor phase coolant to maintain the desired temperature and pressure in the chamber 124. In this example, the heat exchanger 118 is positioned substantially above a level of the liquid coolant 26 in the chamber 124. In addition, as in the vehicle battery temperature control system 10, the vehicle battery temperature control system 100 includes a sensor 132, a controller 134 and a fan 136. The controller 134 can be any suitable type of computer, microprocessor or control device as discussed above with regard to controller 34.

The heat exchanger 118 includes a thermoelectric device assembly 140. In this example, the thermoelectric device assembly 140 includes a first plurality of fins (e.g., cooling fins) 142 formed on a first side and extending into an upper end of the chamber 124, and a second plurality of fins (e.g., cooling fins) 144 formed on a second side opposite to the first side. Hence, the fins 142 and 144 transfer thermal energy from the vapor phase coolant to the environment external of the system 100, and thus assist in cooling and condensing the vapor phase coolant to the liquid phase. The fins 142, in particular, also can transfer thermal energy from the thermoelectric device assembly 140 to the vapor phase coolant.

The thermoelectric device assembly 140 is an electrical type of heating device, or any other type of appropriate heating device. As understood in the art, the thermoelectric device assembly 140 is operable to provide a low temperature side and a high temperature side, depending on the polarity of the operating voltage applied to the thermoelectric device assembly 140. Accordingly, in the case of cooling the vapor phase coolant 26, the controller 134 controls the application of a voltage to the thermoelectric device assembly 140 to operate the thermoelectric device assembly 140 so that the high temperature side occurs at the top of the thermoelectric device assembly 140 facing outside the chamber 124, thus heating the fins 144, and the low temperature side occurs at the bottom of the thermoelectric device assembly 140 facing inside the chamber 124, thus cooling the fins 142. In this event, the thermoelectric device assembly 140 can operate like a heat pump and draw heat from the interior of the chamber 124 via fins 142. That heat, along with the heat generated by the internal electrical power dissipation in the thermoelectric device assembly 140, results in a hot upper surface of the thermoelectric device assembly 140 that can expend the heat into the environment outside of the chamber 124 via, for example, fins 144.

The thermoelectric device assembly 140 can thus be more efficient at cooling the saturated coolant 26 below the ambient temperature outside the chamber 124. Accordingly, it is possible to cool the saturated coolant 26 to a temperature below the ambient temperature. For example, the saturated coolant 26 can be cooled so that the battery 14 can operate near the center of the target operating temperature range (e.g., at about 30 degrees Celsius) even if the ambient temperature is much higher (e.g., over 40 degrees Celsius).

The sensor 132 is operable in a manner similar to sensor 32 (FIG. 2) to detect when a characteristic of the vapor phase coolant is above a threshold, and to signal operation of the thermoelectric device assembly 140 and/or the fan 136 to increase the removal of thermal energy by the heat exchanger 118 when the characteristic is above the threshold. In this example, the sensor 132 provides a signal to the controller 134 which determines whether the characteristic is above the threshold.

If the characteristic is above the threshold, the controller 134 controls, for example, the thermoelectric device assembly 140 to operate like a heat pump as discussed above and draw heat from the interior of the chamber 124. Furthermore, the controller 134 can control the fan 136 to operate to further assist in dissipating heat from the fins 144. Naturally, the controller 134 can control the thermoelectric device assembly 140 and fan 136 to operate in a cooperative manner (e.g., both on at the same time, either one on at different times, or both off at the same time) to maintain the temperature of the coolant 26 in the chamber 124 within the desired temperature range.

As can be appreciated from the above, the sensor 132 includes a temperature sensor that is operable to sense a temperature of the vapor phase coolant in the chamber 124 as the characteristic. In this event, the threshold can be an upper temperature threshold, such as a temperature threshold at or about 45 degrees Celsius (see FIG. 5). Alternatively, or in addition, the sensor 132 includes a pressure sensor operable to sense a pressure in the chamber 124 as the characteristic. In this event, the threshold can be an upper pressure threshold, such as pressure at or about 1100 kPa (see FIG. 5). Naturally, any suitable temperature threshold or pressure threshold can be used. Accordingly as discussed above with regard to the vehicle battery temperature control system 10, the operation of the thermoelectric device assembly 140 and/or fan 136 enhances the reformation of liquid phase coolant from the vapor phase coolant by the heat exchanger 118 to maintain the target pressure and corresponding target temperature of the coolant 26, which results in a stable temperature environment for the battery cell heat sink structure.

In addition, the sensor 132 detects when a characteristic of the vapor phase coolant is below a threshold, and provides a signal to the controller 134. That is, the sensor 132 detects when a temperature and/or pressure of the vapor phase coolant is below a threshold (e.g., about 18 degrees Celsius or about 400 kPa as shown in FIG. 5), and provides a signal to the controller 134. In response, the controller 134 can, for example, control the application of a voltage to the thermoelectric device assembly 140 to control the thermoelectric device assembly 140 to operate so that the high temperature side occurs at the bottom of the thermoelectric device assembly 140 facing inside the chamber 124, thus heating the fins 142, and the low temperature side occurs at the top of the thermoelectric device assembly 140 facing outside the chamber 124, thus cooling the fins 144. In this event, the thermoelectric device assembly 140 can operate like a heat pump and draw heat from the exterior of the chamber 124 via fins 144. That heat, along with the heat generated by the internal electrical power dissipation in the thermoelectric device assembly 140, results in a hot lower surface of the thermoelectric device assembly 140 that can expend the heat into the chamber 124 via, for example, fins 142. This transfer of thermal energy via fins 142 to the vapor phase coolant heats the vapor phase coolant to maintain the target pressure and corresponding target temperature of the coolant 26, and thus the target temperature range of the battery 14. Once the sensor 132 detects that the temperature and/or pressure has reached the threshold, the sensor 132 signals the controller 134 to turn off the thermoelectric device assembly 140. Furthermore, the controller 134 can control the fan 136 and thermoelectric device assembly 140 to operate in a cooperative manner to maintain the target pressure and corresponding target temperature of the coolant 26, which can be below or above the ambient temperature.

### Third Embodiment

Referring now to FIG. 7, a vehicle battery temperature control system in accordance with a third embodiment will now be explained. In view of the similarity between the first, second and third embodiments, the parts of the third embodiment that are identical to the parts of the first and second embodiments will be given the same reference numerals as the parts of the first and second embodiments. Moreover, the descriptions of the parts of the third embodiment that are identical to the parts of the first and second embodiments may be omitted for the sake of brevity. The parts of the third embodiment that differ from the parts of the first and second embodiments will be indicated with different reference numerals.

The vehicle battery temperature control system 200 is illustrated in FIG. 7 in accordance with the third embodiment. The vehicle battery temperature control system 200 includes a battery 14 having a heat sink 20 similar to that described above with regard to vehicle battery temperature control systems 10 and 100. The vehicle battery temperature control system 200 further includes a housing 216 and a heat exchanger 218. The housing 216 includes an insulation member 222 configured to substantially enclose the housing 216. As illustrated, the battery 14 and heat sink 20, housing 216, insulation member 222, heat exchanger 218 and associated components described herein are included in the battery unit 7 shown in FIG. 1.

The housing 216 defines a chamber 224 that is configured to receive the battery 14 and contain a saturated liquid coolant 26 that substantially immerses the heat sink 20 so that the coolant receives the thermal energy from operation of the battery 14 to cause a phase change of the coolant from a liquid phase to a vapor phase as in the vehicle battery temperature control system 10. In this example, the coolant 26 includes 1,1,1,2-Tetrafluoroethane (known as R-134a) or 2,3,3,3-Tetrafluoroprop-1-ene (known as HFO-1234yf). However, the coolant 26 can include any suitable type of refrigerant. Furthermore, the chamber 224 can be configured such that the saturated liquid coolant 26 in the chamber 224 completely immerses the heat sink 20 as discussed above with regard to vehicle battery temperature control systems 10 and 100.

The heat exchanger 218 is configured in an elevated position with respect to the chamber 224 to receive vapor phase coolant from the chamber 224, and remove thermal energy from the vapor phase coolant to change the coolant from the vapor phase to the liquid phase. The heat exchanger 218 also can operate to add thermal energy to the vapor phase coolant to maintain the desired temperature and pressure in the chamber 224. In this example, the heat exchanger 218 is positioned substantially above a level of the liquid coolant 26 in the chamber 214. In addition, as in the vehicle battery temperature control systems 10 and 100, the vehicle battery temperature control system 200 includes a sensor 232 and a controller 234. The controller 234 can be any suitable type of computer, microprocessor or control device as discussed above with regard to controller 34.

The heat exchanger 218 includes a thermoelectric device assembly 240 similar to thermoelectric device assembly 140 discussed above. In this example, the thermoelectric device assembly 240 includes a first plurality of fins (e.g., cooling fins) 242 formed on a first side and extending into an upper end of the chamber 224. As in thermoelectric device assembly 140, the thermoelectric device assembly 240 is operable to provide a low temperature side and a high temperature side, depending on the polarity of the operating voltage applied to the thermoelectric device assembly 240. Accordingly, in the case of cooling the vapor phase coolant 26, the controller 234 controls the application of a voltage to the thermoelectric device assembly 240 to operate the thermoelectric device assembly 240 so that the high temperature side occurs at the top of the thermoelectric device assembly 240 facing outside the chamber 224, and the low temperature side occurs at the bottom of the thermoelectric device assembly 240 facing inside the chamber 224, thus cooling the fins 242. In this event, the thermoelectric device assembly 240 can operate like a heat pump and draw heat from the interior of the chamber 224 via fins 242. That heat, along with the heat generated by the internal electrical power dissipation in the thermoelectric device assembly 240, results in a hot upper surface of the thermoelectric device assembly 240 that can expend the heat into the environment outside of the chamber 224.

The thermoelectric device assembly 240 can thus be more efficient at cooling the saturated coolant 26 below the ambient temperature outside the chamber 224. Accordingly, it is possible to cool the saturated coolant 226 to a temperature below the ambient temperature. For example, the saturated coolant 226 can be cooled so that the battery 14 can operate near the center of the target operating temperature range (e.g., at about 30 degrees Celsius) even if the ambient temperature is much higher (e.g., over 40 degrees Celsius).

Also, a cooling heat exchanger 246 that can include, for example, a condenser, is positioned on a second side of the thermoelectric device assembly 240 opposite to the first side. Hence, the fins 242 transfer thermal energy from the vapor phase coolant to the cooling heat exchanger 246, and to an environment external of the system 200, and thus assist in cooling and condensing the vapor phase coolant to the liquid phase.

The cooling heat exchanger 246 is coupled to, for example, the HVAC system of the vehicle 1 via input conduit 248 and output conduit 250. The temperature of the cooling heat exchanger 246 can be maintained with the air-conditioning (A/C) system of the vehicle 1, and the low temperature side of the A/C cycle can be used to cool part of the cooling heat exchanger 246 in a variety of ways. For example, a coolant can be circulated through the cooling heat exchanger 246 via input conduit 248 and output conduit 250 to enhance cooling. Alternatively, cooled air, such as air coming from the evaporator and/or passenger compartment can be circulated through the cooling heat exchanger 246 via input conduit 248 and output conduit 250 to enhance cooling. Accordingly, this cooling heat exchanger 246 assists in removing thermal energy from the vapor phase coolant via the fins 242 without the use of a fan, for example.

The sensor 232 is operable in a manner similar to sensor 32 (FIG. 2). For example, the sensor 232 is operable to detect when a characteristic of the vapor phase coolant is above a threshold, and to signal operation of the thermoelectric device assembly 240 to increase the removal of thermal energy by the heat exchanger 218 when the characteristic is above the threshold. In this example, the sensor 232 provides a signal to a controller 234 which determines whether the characteristic is above the threshold. If the characteristic is above the threshold, the controller 234 controls, for example, the thermoelectric device assembly 240 to operate like a heat pump as discussed above and draw heat from the interior of the chamber 224.

As can be appreciated from the above, the sensor 232 includes a temperature sensor that is operable to sense a temperature of the vapor phase coolant in the chamber 224 as the characteristic. In this event, the threshold can be an upper temperature threshold, such as a temperature threshold at or about 45 degrees Celsius (see FIG. 5). Alternatively, or in addition, the sensor 232 includes a pressure sensor operable to sense a pressure in the chamber 224 as the characteristic. In this event, the threshold can be an upper pressure threshold, such as pressure at or about 1100 kPa (see FIG. 5). Naturally, any suitable temperature threshold or pressure threshold can be used. Accordingly as discussed above with regard to the vehicle battery temperature control system 10, the operation of the thermoelectric device assembly 240 enhances the reformation of liquid phase coolant from the vapor phase coolant by the heat exchanger 218 to maintain the target pressure and corresponding target temperature of the coolant 26, which results in a stable temperature environment for the battery cell heat sink structure.

In addition, as with sensor 132, the sensor 232 is operable to detect when a characteristic of the vapor phase coolant is below a threshold, and to signal operation of the heat exchanger 218 that provides thermal energy to the vapor phase coolant via the fins 242 when the characteristic is below the threshold. That is, the sensor 232 detects when a characteristic of the vapor phase coolant is below a threshold (e.g., about 18 degrees Celsius or about 400 kPa as shown in FIG. 5), and provides a signal to the controller 234. In response, the controller 234 controls the application of a voltage to the thermoelectric device assembly 240 to operate the thermoelectric device assembly 240 so that the high temperature side occurs at the bottom of the thermoelectric device assembly 240 facing inside the chamber 224, thus heating the fins 242, and the low temperature side occurs at the top of the thermoelectric device assembly 240 facing outside the chamber 224. In this event, the thermoelectric device assembly 240 can operate like a heat pump and draw heat from the exterior of the chamber 224. That heat, along with the heat generated by the internal electrical power dissipation in the thermoelectric device assembly 240, results in a hot lower surface of the thermoelectric device assembly 240 that can expend the heat into the chamber 224. Also, the controller 234 can control, for example, valves (not shown) in a manner similar to that discussed below with regard to FIG. 8, to circulate heated liquid or air via the HVAC system of the vehicle 1 through the heat exchanger 246, to thus increase the transfer of thermal energy by the thermoelectric device assembly 240.

The thermoelectric device assembly 240 thus transfers thermal energy via fins 242 to the vapor phase coolant, thereby heating the vapor phase coolant to maintain the target pressure and corresponding target temperature of the coolant 26, and thus the target temperature range of the battery 14. Once the sensor 232 detects that the temperature and/or pressure has reached the threshold, the sensor 232 signals the controller 234 to turn off the thermoelectric device assembly 240 and, if applicable, to control the valves to discontinue the flow of heated liquid or air into the heat exchanger 246.

### Fourth Embodiment

Referring now to FIG. 8, a vehicle battery temperature control system in accordance with a fourth embodiment will now be explained. In view of the similarity between the first through third embodiments, the parts of the fourth embodiment that are identical to the parts of the first through third embodiments will be given the same reference numerals as the parts of the first through third embodiments. Moreover, the descriptions of the parts of the fourth embodiment that are identical to the parts of the first through third embodiments may be omitted for the sake of brevity. The parts of the fourth embodiment that differ from the parts of the first through third embodiments will be indicated with different reference numerals.

The vehicle battery temperature control system 300 is illustrated in FIG. 8 in accordance with the fourth embodiment. The vehicle battery temperature control system 300 includes a battery 14 having a heat sink 20 similar to that described above with regard to vehicle battery temperature control systems 10, 100 and 200. The vehicle battery temperature control system 300 further includes a housing 316 and a heat exchanger 318. The housing 316 includes an insulation member 322 configured to substantially enclose the housing 316. As illustrated, the battery 14 and heat sink 20, housing 316, insulation member 322, heat exchanger 318 and associated components described herein are included in the battery unit 7 shown in FIG. 1.

The housing 316 defines a chamber 324 that is configured to receive the battery 14 and contain a saturated liquid coolant 26 that substantially immerses the heat sink 20 so that the coolant receives the thermal energy from operation of the battery 14 to cause a phase change of the coolant from a liquid phase to a vapor phase as in the vehicle battery temperature control system 10. In this example, the coolant 26 includes 1,1,1,2-Tetrafluoroethane (known as R-134a) or 2,3,3,3-Tetrafluoroprop-1-ene (known as HFO-1234yf). However, the coolant 26 can include any suitable type of refrigerant. Furthermore, the chamber 324 can be configured such that the saturated liquid coolant 26 in the chamber 324 completely immerses the heat sink 20 as discussed above with regard to vehicle battery temperature control systems 10, 100 and 200.

The heat exchanger 318 is configured in an elevated position with respect to the chamber 324 to receive vapor phase coolant from the chamber 324, and remove thermal energy from the vapor phase coolant to change the coolant from the vapor phase to the liquid phase. The heat exchanger 318 also can operate to add thermal energy to the vapor phase coolant to maintain the desired temperature and pressure in the chamber 324. In this example, the heat exchanger 318 is positioned substantially above a level of the liquid coolant 26 in the chamber 314.

The heat exchanger 318 includes a first plurality of fins 342 formed on a first side and extending into an upper end of the chamber 324. Also, a heat exchanger 346 that can include, for example, a condenser, is positioned on a second side opposite to the first side. Hence, the fins 242 transfer thermal energy from the vapor phase coolant to the cooling heat exchanger 346, and to an environment external of the system 300, and thus assist in cooling and condensing the vapor phase coolant to the liquid phase. Alternatively, the fins 242 can transfer thermal energy to the vapor phase coolant from the heat exchanger 346, and thus assists in heating the vapor phase coolant as necessary.

The heat exchanger 346 is coupled to, for example, the HVAC system of the vehicle 1 via input conduit 348 and output conduit 350. The temperature of the cooling heat exchanger 346 can be maintained with the air-conditioning (A/C) system of the vehicle 1, and the low temperature side of the A/C cycle can be used to cool part of the cooling heat exchanger 346 in a variety of ways. For example, a coolant can be circulated through the cooling heat exchanger 346 via input conduit 348 and output conduit 350 to enhance cooling. Alternatively, cooled air, such as air coming from the evaporator and/or passenger compartment can be circulated through the heat exchanger 346 via input conduit 348 and output conduit 350 to enhance cooling. Accordingly, this cooling heat exchanger 346 assists in removing thermal energy from the vapor phase coolant via the fins 342 without the use of a fan, for example. Furthermore, the valves 348 and 350 can couple the heat exchanger 346 to receive heated air or coolant from, for example, the HVAC system of the vehicle to provide thermal energy to the vapor phase coolant via the fins 342 to enhance heating.

In addition, as in the vehicle battery temperature control systems 10, 100 and 200, the vehicle battery temperature control system 300 includes a sensor 332 and a controller 334. The controller 334 can be any suitable type of computer, microprocessor or control device as discussed above with regard to controller 34. The sensor 332 is operable in a manner similar to sensor 32 (FIG. 2) to detect when a characteristic of the vapor phase coolant is above a threshold, and can control the operation of valves 352 and 354 to allow the flow of coolant through the heat exchanger 346 as discussed above to enhance cooling. When the sensor 332 detects when a characteristic of the vapor phase coolant is below a threshold (e.g., about 18 degrees Celsius or about 400 kPa as shown in FIG. 5), the sensor 332 provides a signal to the controller 334. In response, the controller 334 controls the values 352 and 354 to couple the heat exchanger 346 to allow the flow of heated air or coolant to maintain the target pressure and corresponding target temperature of the coolant 26, and thus the target temperature range of the battery 14. Accordingly, heating or cooling of the coolant 26 can be achieved without the use of an electronic heating device such as a thermoelectric device assembly 140 or 240 as discussed above.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), directional terms such as “frontward”, “upward” and “above,” as well as any other similar directional terms refer to those directions of a vehicle. Accordingly, these terms, as utilized to describe the present invention should be interpreted relative to a vehicle equipped with the vehicle battery temperature control systems described herein.

The terms “detect” or “sense,” and their variations, as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle battery temperature control system comprising:
a battery operable to discharge thermal energy, the battery having a heat sink configured to transfer the thermal energy therefrom;
a housing having a chamber formed therein that is configured to receive the battery and contain a saturated liquid coolant that substantially immerses the heat sink so that the coolant receives the thermal energy from operation of the battery to cause a phase change of the coolant from a liquid phase to a vapor phase; and
a heat exchanger configured to receive vapor phase coolant from the chamber and remove thermal energy from the vapor phase coolant to change the coolant from the vapor phase to the liquid phase, and being further configured to return the liquid phase coolant to the chamber.

2. The vehicle battery temperature control system according to claim 1, further comprising
a sensor operable to detect when a characteristic of the vapor phase coolant is above a threshold, and to signal operation of a fan that increases the removal of thermal energy by the heat exchanger when the characteristic is above the threshold.

3. The vehicle battery temperature control system according to claim 2, wherein
the sensor includes a temperature sensor operable to sense a temperature of the vapor phase coolant as the characteristic.

4. The vehicle battery temperature control system according to claim 2, wherein
the sensor includes a pressure sensor operable to sense a pressure in the chamber as the characteristic.

5. The vehicle battery temperature control system according to claim 1, further comprising
an insulation member configured to substantially enclose the housing.

6. The vehicle battery temperature control system according to claim 1 wherein
the chamber is configured such that the saturated liquid coolant in the chamber completely immerses the heat sink.

7. The vehicle battery temperature control system according to claim 1 wherein
the heat exchanger is positioned substantially above a level of the liquid coolant in the chamber.

8. The vehicle battery temperature control system according to claim 1 wherein
the heat exchanger includes a condenser fluidly coupled to receive the vapor phase coolant, the condenser being operable to remove heat from the vapor phase coolant to create the liquid phase coolant, and being fluidly coupled to return the liquid phase coolant to the chamber.

9. The vehicle battery temperature control system according to claim 1 wherein
the heat exchanger includes a thermoelectric device assembly.

10. The vehicle battery temperature control system according to claim 9 wherein
the thermoelectric device assembly includes a first plurality of cooling fins formed on a first side and extending into an upper end of the chamber.

11. The vehicle battery temperature control system according to claim 10 wherein
the thermoelectric device assembly further includes a second plurality of cooling fins formed on a second side opposite to the first side.

12. The vehicle battery temperature control system according to claim 10 wherein
the thermoelectric device assembly further includes a heat exchanger disposed on a second side opposite to the first side.

13. The vehicle battery temperature control system according to claim 1 wherein
the saturated liquid coolant includes one of 1,1,1,2-Tetrafluoroethane and 2,3,3,3-Tetrafluoroprop-1-ene.

14. A vehicle battery temperature control method comprising:
operating a battery having a heat sink and disposed in a chamber of a housing containing a saturated liquid coolant into which the battery is immersed, so that the heat sink transfers thermal energy from the battery to the coolant to cause a phase change of the coolant from a liquid phase to a vapor phase;
operating a heat exchanger to receive vapor phase coolant from the chamber and remove thermal energy from the vapor phase coolant to change the coolant from the vapor phase to the liquid phase; and
operating the heat exchanger to return the liquid phase coolant to the chamber.

15. The vehicle battery temperature control method according to claim 14, further comprising
detecting when a characteristic of the vapor phase coolant is above a threshold; and
operating a fan to increase the removal of thermal energy by the heat exchanger when the characteristic is detected as being above the threshold.

16. The vehicle battery temperature control method according to claim 15, wherein
the detecting includes operating a temperature sensor to sense a temperature of the vapor phase coolant as the characteristic.

17. The vehicle battery temperature control method according to claim 15, wherein
the detecting includes operating a pressure sensor to sense a pressure in the chamber as the characteristic.

18. The vehicle battery temperature control method according to claim 14 wherein the heat exchanger operating includes
operating the heat exchanger that is positioned substantially above a level of the liquid coolant in the chamber to receive the vapor phase coolant from above the level of the liquid.

19. The vehicle battery temperature control method according to claim 14 wherein the heat exchanger operating includes
operating a condenser of the heat exchanger to receive the vapor phase coolant and remove heat from the vapor phase coolant to create the liquid phase coolant; and
operating the condenser to return the liquid phase coolant to the chamber.

20. The vehicle battery temperature control method according to claim 14 wherein the heat exchanger operating includes
operating a thermoelectric device assembly of the heat exchanger to receive the vapor phase coolant and remove heat from the vapor phase coolant to create the liquid phase coolant, and to return the liquid phase coolant to the chamber.
